(19) United States
(12) Patent Application Publication
(10) Pub. No.: US 2013/0190449 A1
(43) Pub. Date: Jul. 25, 2013

(54) METHOD OF PRODUCING GRAPHENE OXIDE AND ITS USES

(71) Applicants: Ian Kinloch, Manchester (GB); Robert Young, Manchester (GB); Jonathan Rourke, Manchester (GB); Neil R. Wilson, Manchester (GB)

(72) Inventors: Ian Kinloch, Manchester (GB); Robert Young, Manchester (GB); Jonathan Rourke, Manchester (GB); Neil R. Wilson, Manchester (GB)

(21) Appl. No.: 13/878,057

(22) PCT Filed: Oct. 6, 2011
(86) PCT No.: PCT/GB11/51918

§ 371 Date: Apr. 5, 2013

(30) Foreign Application Priority Data
Oct. 7, 2010 (GB) 1016925.8

(51) Int. Cl. C01B 31/04

(52) U.S. Cl. CPC C01B 31/043
USPC 525/50; 423/415.1; 423/448; 570/143

(57) ABSTRACT

This invention relates to a method for the production of graphene oxide and its use in various applications. The invention provides a method for the preparation of graphene oxide which involves treating a mixture of graphene oxide and impurities with a solution of a base. The impurities in the graphene oxide include oxygen-containing species that are associated with it i.e. bound to the graphene oxide but which are not covalently bonded to the graphene. The graphene oxide of the present invention has improved purity relative to the poorly characterised graphene oxide that is produced by existing methods.

This invention relates to a method for the production of graphene oxide and its use in various applications.

### BACKGROUND

Graphene, first isolated in 2004, has a number of remarkable properties. It is both the strongest and thinnest material known to man, it is transparent and it is an excellent conductor both of heat and of electricity. The list of possible industrial applications is endless but the reliability and scalability of the current production methods are hampering progress.

Graphene oxide (GO) is cheap to make in bulk and easy to process and provides a potential route to large quantities of graphene [Park, S.; Ruoff, R. S. Nat Nano 2009, 4, 217-224., Dreyer, D. R.; Park, S.; Bielawski, C. W.; Ruoff, R. S. Chemical Society Reviews 2010, 39, 228-240.]. It is also a starting point for further functionalisation to create chemically modified graphenes (CMGs) e.g. for use in composite materials [Wang, H.; Hao, Q.; Yang, X.; Lu, L.; Wang, X. ACS Applied Materials & Interfaces 2010, 2, 821-828., Ramanathan, T.; Abdala, A. A.; Stankovich, S.; Dikin, D. A.; Herrera-Alonso, M.; Piner, R. D.; Adamson, D. H.; Schniepp, H. C.; Chen, X.; Ruoff, R. S.; Nguyen, S. T.; Aksay, I. A.; Prud'Homme, R. K.; Brinson, L. C. Nat Nano 2008, 3, 327-331.], for light-harvesting [Liu, Z.-B.; Xu, Y.-F.; Zhang, X.-Y.; Zhang, X.-L.; Chen, Y.-S.; Tian, J.-G. The Journal of Physical Chemistry B 2009, 113, 9681-9686.], or as sensors [Fowler, J. D.; Allen, M. J.; Tung, V. C.; Yang, Y.; Kaner, R. B.; Weiller, B. H. ACS Nano 2009, 3, 301-306. Robinson, J. T.; Perkins, F. K.; Snow, E. S.; Wei, Z.; Sheehan, P. E. Nano Letters 2008, 8, 3137-3140.].

GO is derived from the exfoliation of graphite oxide, and its structure despite over one hundred years of investigation, is still subject to debate [Bielawski, C. W.; Ruoff, R. S. Chemical Society Reviews 2010, 39, 228-240. Szabo, T.; Berkesi, O.; Forgo, P.; Josepovits, K.; Sanakis, Y.; Petridis, D.; Dekany, I. Chemistry of Materials 2006, 18, 2740-2749.].

Understanding the chemical and physical structure of GO is a necessary step towards its controllable functionalisation for CMGs and complete reduction back to graphene.

Depending on the starting material and oxidative conditions the composition of GO can vary significantly, but extensive study has resulted in a number of accepted properties [Dreyer, D. R.; Park, S.; Bielawski, C. W.; Ruoff, R. S. Chemical Society Reviews 2010, 39, 228-240]. Fully oxidised GO forms stable aqueous suspensions and has an atomic C:O ratio of roughly 2:1. The dominant surface functional groups are epoxides and alcohols, with carboxylic acid and other keto groups on the edges. GO is thermally unstable with heating to more than around 80° C. changing the composition and reducing the C:O ratio. Recent high resolution STM [Gomez-Navarro, C.; Weitz, R. T.; Bittner, A. M.; Scolari, M.; Mews, A.; Burghard, M.; Kern, K. Nano Lett. 2007, 7, 3499-3503.] and TEM [Mkhoyan, K. A.; Contryman, A. W.; Silcox, J.; Stewart, D. A.; Eda, G.; Mattevi, C.; Miller, S.; Chhowalla, M. Nano Lett. 2009, 9, 1058-1063., Golmez-Navarro, C.; Meyer, J. C.; Sundaram, R. S.; Chuvilin, A.; Kurasch, S.; Burghard, M.; Kern, K.; Kaiser, U. Nano Letters 2010, 10, 1144-1148., Pantelic, R. S.; Meyer, J. C.; Kaiser, U.; Baumeister, W.; Plitzko, J. M. Journal of Structural Biology 2010, 170, 152-156.] studies have concluded that the degree of functionalisation is highly heterogeneous with nanometre scale predominantly graphitic islands observable amongst disordered/amorphous regions.

Deoxygenation of Exfoliated Graphite Oxide under Alkaline Conditions: A Green Route to Graphene Preparation, X Fan et al, Advanced Materials, 2008, 20, 4490-4493, DOI: 10.1002/adma.200801306 describes a method which they claim “deoxygenate” graphene oxide, resulting “stable aqueous graphene suspensions” (Pg 4490, Col 1, Para 2). The paper clearly distinguishes that initial graphene oxide and resultant graphene are distinct structures. For example, graphene oxide has “abundant epoxide and hydroxyl groups” where as graphene-based materials have “plentiful sp2 carbon atoms”. The author's belief between the two structures is most clearly highlighted in FIG. 1a, where the oxygen containing groups in the GO are removed the bonds annealed to sp2 bonds in the graphene. This belief is supported by their comments on page 4491 that state that “the deoxygenation of the exfoliated GO under alkaline conditions appears to be the reverse of the oxidation reaction of graphite in strong acids”.

### BRIEF SUMMARY OF THE DISCLOSURE

According to one aspect of the current invention, there is provided a method for the preparation of graphene oxide, wherein the method comprises the steps of:
1) treating a mixture of graphene oxide and impurities with a solution of a base; and
2) separating graphene oxide from the basified impurities.

The impurities in the graphene oxide include oxygen-containing species that are associated with i.e. bound to the graphene oxide but which are not covalently bonded to the graphene. This material is also known as oxidative debris or oxygen-containing fragments and is distinguished from the covalently bound oxygen-containing species that remain in the graphene oxide after base washing.

The graphene oxide of the present invention has improved purity relative to the poorly characterised graphene oxide that is produced by existing methods. The GO is washed with a solution of base in a suitable vessel such as a flask. It is not necessary to employ any protective atmosphere during purification.

The base should ideally be an aqueous base. This allows removal of adsorbed oxygen species i.e. the oxidative debris from the surface of the graphene oxide as originally produced without substantially disturbing the covalently bound oxygen species. The adsorbed oxygen-containing species are bound to the surface of the graphene oxide via Van der Waals type bonding or similar attractive forces and not through any direct chemical bonding. These species represent a significant part of the oxygen in graphene oxide as-produced and may account for up to 20% or 25% of the crude graphene oxide by weight when initially produced, though sometimes it is not more than 10% of the total weight.

The purified material is then collected in the form of a solid from the base solution by any suitable method normally employed for recovery of small scale solid material; centrifugation is the preferred method. The resulting collected solid material may optionally be washed in pure solvent eg distilled water, alcohol such as methanol, ethanol or isopropanol, to purify it further.

The collected solid material is then allowed to dry. Drying may take place at ambient or elevated temperatures of from 40 to 100 degrees centigrade. Drying may be effected at ambient pressure or under a reduced pressure in the range of 1 to 50 mmHg using conventional apparatus such as a rotary evaporator or a vacuum line.

In an embodiment, the solvent used for the base is selected from water and a C1-C6 alcohol. Ideally the solvent when not simply water is a C1-C4 alcohol, preferably ethanol or propanol either alone or more usually mixed with water. However, other polar solvents may also be used such as THF, dioxane, C1-C6 dialkyl ethers, phenols, ketones such C1-C6 dialkyl ketones and C1-C6 alkyl aryl ketones,

The GO of the present invention has reduced impurities relative to the known poorly characterised material. In an embodiment, the material has at least 10% fewer impurities that conventional GO produced by known methods. In an embodiment, the reduction in impurities in the GO of the invention is at least 20%, more preferably is at least 50%, and most preferably is at least 90% lower (i.e. the impurities are less than 10% of those present in conventional GO). In one embodiment, the presence of impurities is reduced by 95% compared to conventional GO.

The GO of the invention contains little of the oxidative debris and thus contains less than 3% by weight of non-covalently bound oxygen-containing species. Preferably, the material contains less than 2% or 1% by weight of the non-covalently bound species. In a most preferred embodiment, the non-covalently bound oxygen-containing species in the treated product of the invention accounts for 0.5% or less by weight of the GO, and in some cases it may even be as low as 0.2% or 0.1% by weight. The material described by Fan et al. is different from graphene oxide as proposed by the current invention and can be distinguished in terms of the change in the nature of the covalent bonding of the final material compared to the initial material. Fan et al.'s procedure turns “GO [that was] prepared and purified according to the Hummers [sic] method” to “solid graphene samples” (pg 4492-4493, Experimental section). Given their understanding of graphene's structure as referenced above, this statement shows that the authors' belief that their deoxygenating procedure has annealed the sp3 nature of GO to sp2, i.e. they have reduced the carbon bonding. Whereas, in the current invention, the procedure simply removes physic-absorbed, small aromatic species, leaving the underlying GO flake's covalent bonding unchanged by the process.

In an embodiment the base is a carbonate, a bicarbonate, a hydroxide or an alkoxide of a group 1 metal.

In another embodiment the base is a carbonate of a group 2 metal.

In a preferred embodiment the base is a hydroxide of a group 1 metal. Water soluble hydroxides of group 2 metals may also be used.

In a further embodiment the base is NaOH or KOH; preferably it is NaOH.

In an embodiment the base is an aqueous solution of a base. Alternatively, the base solution may be an aqueous/alcoholic mixture.

Alternatively, the base may be an alkali metal alkoxide of a C₁₋₆ alcohol.

In an embodiment the concentration of the aqueous base is between 0.001 M and 10 M.

In an embodiment the concentration of the aqueous base is between 0.01 M and 2 M, and more preferably it is between 0.5 and 1.0 M

In an embodiment the treatment with base occurs at a temperature between −10° C. and 200° C.

In an embodiment the treatment with base occurs at room temperature.

In an alternative embodiment the treatment with base occurs at the temperature of the solution at reflux.

In an embodiment the concentration of base is 0.01 M and the treatment with base occurs at the temperature of the solution at reflux.

In an embodiment the concentration of base is 1 M and the treatment with base occurs at room temperature.

In an embodiment the graphene oxide formed according to the invention has an atomic C:O ratio of between 20:1 and 1:1, though more preferably it is between 10:1 and 1:1, and most preferably from 8:1 to 4:1.

In a particularly preferred embodiment the graphene oxide formed according to the invention has an atomic C:O ratio of from 6:1 to 4:1 and is ideally around 4:1.

In an embodiment, there is provided a method for the preparation of graphene oxide, wherein the method comprises the steps of:
1) oxidising graphite;
2) isolating a mixture of graphene oxide and impurities;
3) treating the a mixture with a base; and
4) separating graphene oxide from the basified impurities.

The recovered graphene oxide may be washed and dried or may simply be dried.

The step of base washing the as-produced GO may include base washing one or more times, eg 2, 3 or 4 times. If several base washing steps are performed, these may follow each other immediately or be interspersed by other steps such as aqueous washing and/or drying steps. The base used in each step may be the same or different.

The graphite starting material is readily available and is prepared using known methods. The Hummers method is a well known method for preparing GO: W. S. Hummers, R. E. Offeman, JACS 1958, 80, 1339; b) G. Eda, G. Fanchini, M. Chhowalla,

Nat Nano 2008, 3, 270; c) N. R. Wilson, P. A. Pandey, R. Beanland, R. J. Young, I. A. Kinloch, L.

Gong, Z. Liu, K. Suenaga, J. P. Rourke, S. J. York, J. Sloan, ACS Nano 2009, 3, 2547.

In an embodiment the oxidation of graphite is performed using a modified Hummers method.

In an embodiment the oxidation of graphite is performed using a Hummers method.

In an embodiment the oxidation of graphite is performed using a Staudenmaier method.

According to another aspect of the invention, there is provided a method for the preparation of graphene, wherein the method comprises the steps of:
1) oxidising graphite;
2) isolating a mixture of graphene oxide and impurities;
3) treating the mixture with a base;
4) separating graphene oxide from the basified impurities; and
5) converting the purified graphene oxide to graphene under reductive conditions.

Any conventional reducing conditions may be used eg H₂ or another reducing atmosphere such as H₂/CO etc to reduce GO.

The washed and purified graphene oxide (GO) of the invention is a novel material in its own right. This material is characterised by a carbon to oxygen content of from 1:1 to 10:1 and is obtainable by treating GO produced by known methods with base in the manner disclosed above. This material is characterised by the fact that if treated with aqueous base eg. 1.0M NaOH, substantially no further weight loss is observed due to loss of further oxidative debris that is loosely associated with the GO, i.e. material which is not covalently bound. This material can thus also be characterised by having a high proportion of more than about at least 80% by weight and more usually at least 90% by weight of the material comprised of covalently bound carbon and oxygen. In a preferred embodiment, the covalently bound carbon and oxygen species account for at least 95%, and more preferably at least 96%, 98% or 99% by weight of the material comprised of covalently bound carbon and oxygen. Preferably, at least 99.5% by weight is covalently bound material. Most preferably it is 99.8% and in some cases it can be as high as 99.9% by weight. The oxygen-containing part of the material will thus contain almost exclusively 1,2-epoxides, hydroxides, ketones and carboxylic acid groups. These are covalently bound to the graphene framework and / or each other by conventional chemical bonds.

Thus, another aspect of the present invention provides GO substantially free of non-covalently bound oxygen-containing species. In this aspect, “substantially free” means that at least 90% by weight of the carbon-oxygen species is covalently bound and the balance (represented by the oxidative debris) is less than 10% by weight of non-covalently bound oxygen-containing species.

The GO of the present invention may be used as the starting material for other derivatives of graphene. Thus GO can be treated with fluorine or a source of fluorine to produce fluorographene (FG). Similarly, other derivatives may be prepared by reaction of the GO of the present invention with suitable reagents. In each case, the resulting product may be obtained in good yield and thus therefore represents a viable synthetic approach for graphene derivatives.

According to another aspect of the invention there is provided a method for the preparation of chemically modified graphenes wherein the method comprises the steps of:
1) oxidising graphite;
2) isolating a mixture of graphene oxide and impurities;
3) treating the mixture with a base;
4) separating graphene oxide from the basified impurities; and
5) converting the purified graphene oxide to chemically modified graphenes by reaction with one or more chemically reactive species.

In an embodiment the chemically modified graphenes can be used in composite materials, for light harvesting, or as sensors.

In another aspect of the invention there is provided a method for the preparation of effective surfactants for the direct dispersion of graphene; wherein the method comprises the steps of
1) oxidising graphite;
2) isolating a mixture of graphene oxide and impurities;
3) treating the mixture with a base;
4) separating graphene oxide from the basified impurities; and
5) acidifying and isolating basified impurities to obtain effective surfactants for the direct dispersion of graphene.

### BRIEF DESCRIPTION OF THE DRAWINGS

Embodiments of the invention are further described hereinafter with reference to the accompanying drawings, in which:

FIG. 1. Photograph of 0.5 mg ml⁻¹ GO suspension in NaOH (concentrations as marked) within 30 s of addition of the NaOH (top), and after three hours (bottom).

FIG. 2. Thermogravimetric analysis in air of as-produced GO (aGO, top) and the two components after base-washing; the black precipitate (bwGO, middle), and the remaining water soluble fraction (OD, bottom).

FIG. 3. FTIR absorption spectra of as-produced GO (aGO, top), bwGO (middle), and OD (bottom).

FIG. 4.(a) C 1s XPS spectra of aGO (top) and OD (bottom). (b) Raman spectroscopy of aGO (top) and OD (bottom) using 633 nm laser excitation.

### DETAILED DESCRIPTION

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Here we show that GO, as produced by the modified Hummers' method, is a meta-stable mixture of functionalized graphene sheets decorated by oxidative debris, which acts as a surfactant to stabilise aqueous GO suspensions. We also show that base-washing GO can be used to separate the two components. The larger component by mass contains graphene-like sheets that are oxidatively functionalised with a C:O ratio of roughly 4:1, are conducting and cannot easily be resuspended in water. The other component is water soluble oxidative debris consisting of large oxygenated organic compounds such as fulvic acids.

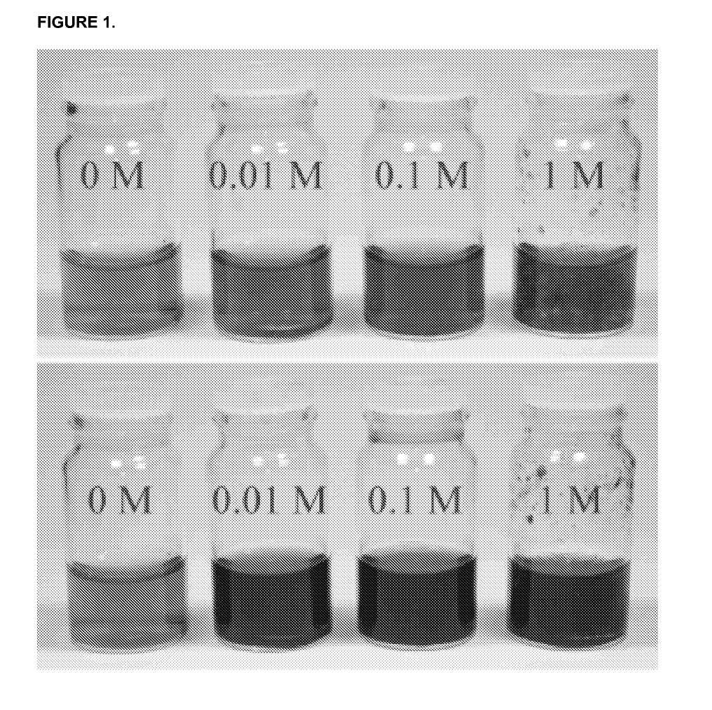

Graphene oxide was prepared by a modified Hummers' method,¹⁸ characterisation of the resultant material by AFM and TEM showing complete exfoliation. The effect of treating this GO with a number of different concentrations of NaOH is demonstrated in FIG. 1.

At high concentration (1 M NaOH) the initially clear brown suspension rapidly separates into a black aggregation and an essentially colourless supernatant solution. At lower concentration (e.g. 0.01 M) the GO darkens over time to a stable black suspension. Refluxing GO treated with low concentration NaOH for 1 hour results in aggregation and separation of the black component giving a mixture that resembles that that arises from treatment with high concentration NaOH. It is important to note refluxing GO in pure water, or in acidic solution had no discernible effect on the GO. The black aggregate was separated by centrifugation, reprotonated with HCl, washed with distilled water and dried under vacuum. The resultant black powder (referred to as bwGO from now on) cannot be resuspended in water by vigorous stirring or sonication. The supernatant liquid was also reprotonated and dried (now referred to as OD). Careful analysis of the mass of the two components gave a mass balance, with bwGO being 65±5% of the mass of GO added and OD 35±5%.

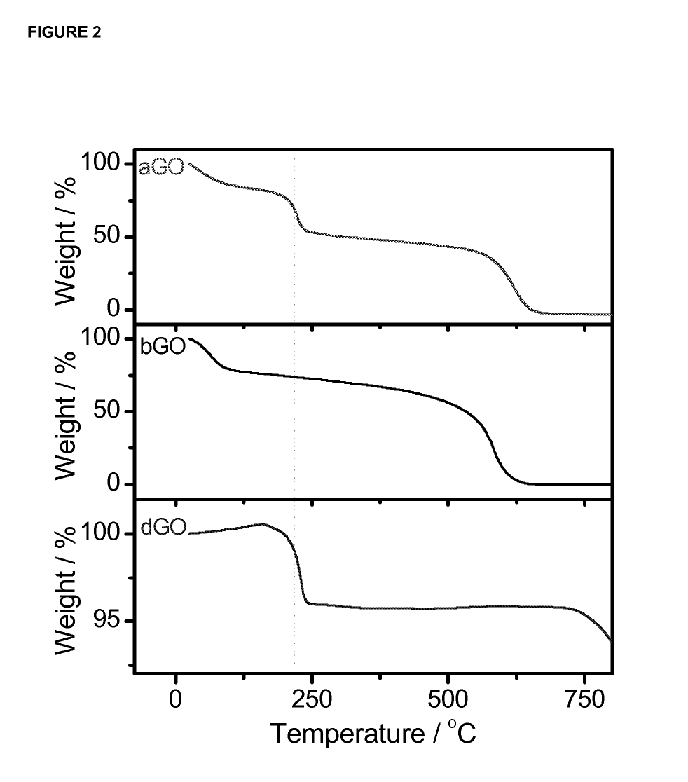

Thermogravimetric analysis (TGA) of the as-produced GO (aGO), bwGO and OD are given in FIG. 2. aGO shows a mass loss at around 200° C., previously attributed to the decomposition of functional groups, and a mass loss of roughly twice the size at around 600° C. which has been attributed to sublimation or burning of the damaged graphitic regions.¹⁹ TGA of bwGO shows a significantly reduced mass loss at around 200° C. and complete mass loss at around 600° C. A significant mass loss at around 200° C. is seen for OD but none at around 600° C., suggesting there are no graphitic regions in this fraction.

The FTIR absorption spectrum of aGO shows a broad feature at 3000 to 3,800 c^{m-1}, v(C—OH, COOH, _{H2}O), and several sharper peaks between 1000 and 1800 c^{m-1}. These lower frequency peaks have variously been ascribed to epoxide, hydroxyl, carboxyl, ketones and s^{p2}-hybridized C—C bonding. OD has a similar FTIR spectrum to aGO, whilst the spectra of bwGO is comparatively featureless, the exception being at around 1630 c^{m-1} where an absorption peak is seen in aGO and bwGO but not OD. We tentatively assign this peak to the in-plane vibrations of sp²-hybridized C—C. From this IR data we conclude that OD is heavily functionalised with similar groups to aGO, whilst the degree of functionalisation is reduced in bwGO.

Whilst it has been known for some time that the addition of base to graphite oxide changes the colour, and that acidification does not reverse the colour-change (resulting instead in coagulation), the proposed explanation that the base disaggregates the graphite oxide cannot be valid for already exfoliated GO. Given the functionalities accepted as being present in GO (alcohols, epoxides, ketones and carboxyl groups) we cannot expect any irreversible chemical reaction to take place upon refluxing in mildly basic conditions. Instead, we suggest that GO actually consists of two distinct components: the majority by mass being large functionalised graphene-like sheets (the bwGO) together with small, more highly oxidised, fragments or debris (the OD). In acidic or neutral conditions the debris is adhered to the graphene-like sheets of GO by a combination of it-it stacking and hydrogen bonds forming relatively strong non-covalent bonds. Upon treatment with base, the interaction between the oxidative debris and underlying functionalised graphene sheet in basic conditions becomes repulsive due to the negative charge on the deprotonated debris. Once separated, it would appear that the two components cannot be recombined, and hence the original mixture is metastable. The material of interest in the present invention is the bwGO which contains little or no oxidative debris.

A solution of the OD material passes through 0.22 μm filter membrane leaving no residue behind, indicating that no large graphene-like sheets are in this component. Mass-spectrometry of the OD found evidence for highly oxidised small fragments.

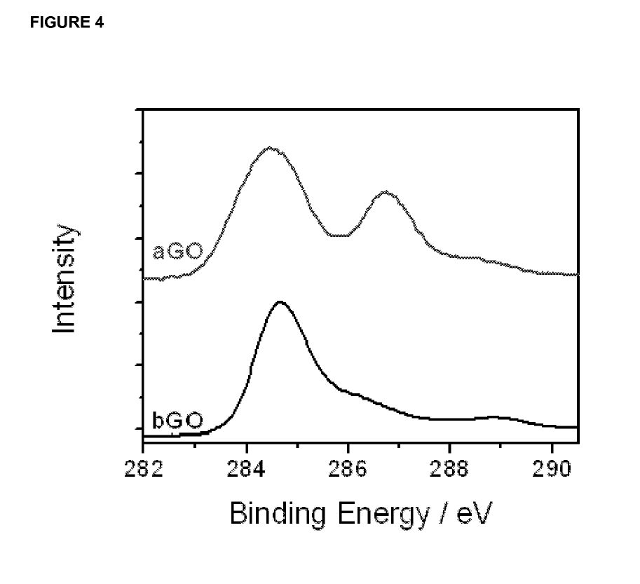

Although not soluble in water, bwGO could be dispersed in N-methylpyrrolidinone (NMP) by sonication to form an unstable suspension. AFM and TEM analysis of bwGO deposited from this suspension showed the presence of large sheets, up to μms in diameter, similar in size to those seen in aGO. XPS analysis of aGO and bwGO is given in FIG. 4a. The C 1s XPS spectra of aGO is consistent with previous reports. The peak at around 284.5 eV is due to C bonded to C, whilst the higher binding energy components, which are greatly reduced in bwGO, are due primarily to C bonded to O (complete fitting and discussion is given in Supporting Information). This is consistent with the O 1s spectra and enables the C:O ratio to be calculated; here for aGO C:O=2:1 and for bwGO C:O=4:1. The degree of oxidative functionality is clearly reduced in the bwGO compared to the aGO, but is still significant.

Raman spectroscopy is an important diagnostic tool for the analysis of graphite-like materials such as graphene. Their strong Raman response is due to resonant enhancement by C—C π states and the response of more disordered carbon-based materials is weaker. Mixed samples show Raman responses dominated by the less amorphous, more ordered, graphitic material. The ‘quality’ of graphite-like samples is often studied through analysis of the ‘D’ peak at around 1300 cm⁻¹, which is due to breathing modes in C—C ring structures and whose presence is indicative of defects, and the ‘G’ peak at around 1600 cm⁻¹, which is due to sp² C—C bond stretching. FIG. 4b shows Raman spectra from this region for aGO and bwGO under 633 nm laser excitation. As expected, aGO shows broad D and G peaks, with a ratio of integrated peak intensities of D/G=1.9. The bwGO shows an almost identical response with D/G=1.9. Together with the XPS and TEM results, this confirms that the bwGO consists of oxidatively functionalised graphene-like sheets and suggests that the sheets themselves are not significantly altered by the base wash.

Vacuum filtration of the bwGO from the NMP suspension onto an alumina filter membrane gave a shiny black thin film. Preliminary results on films 0.5-1 μm thick indicate a conductivity of order 10¹ S m⁻¹. This is roughly five orders of magnitude more conducting than aGO, and only an order of magnitude less than values reported for GO reduced by chemical or low-temperature thermal treatments. Such a dramatic enhancement in the conductivity due to removal of oxidation debris is surprising. It is possible that the comparatively strong noncovalent interaction between the debris and the GO sheets, combined with the highly electronegative functional groups on the debris and the single atom thick graphene lattice, is sufficient to alter the electronic structure.

To our knowledge, no other groups have suggested that oxidative debris is an important component of as-produced GO. In high resolution TEM studies prior to imaging GO is typically heated to remove/reduce amorphous material which otherwise masks the graphene-like lattice. Even after heating amorphous regions cover a significant fraction of the area, with only nanometre sized ‘clean’ regions evident between them. Electron diffraction studies of GO without prior heating show the hexagonal graphene-like lattice is retained [Wilson, N. R.; Pandey, P. A.; Beanland, R.; Young, R. J.; Kinloch, I. A.; Gong, L.; Liu, Z.; Suenaga, K.; Rourke, J. P.; York, S. J.; Sloan, J. ACS Nano 2009, 3, 2547-2556.], supporting the interpretation that the amorphous regions are predominantly due to oxidative debris bound to the GO sheets. The oxidative debris clearly has a strong affinity for the graphene-like sheets of GO, and is an effective surfactant. If it can be purified in large quantities it may act as an effective surfactant for the direct dispersion of graphene.

In conclusion, therefore, these results suggest that the GO produced according to the invention is a mixture of functionalised graphene-like sheets together with non-covalently attached oxidative debris. The graphene-like sheets are oxidised, but at a much lower level than current models for GO suggest; conversely, the oxidative debris is more highly functionalised. This mixture appears to be indefinitely stable in water, but remarkably the removal of the oxidative debris can be effected quite easily with a mild base wash, whereupon the more highly functionalised debris dissolves fully into water, leaving a suspension of functionalised sheets. We have yet to find a method of recombining the debris and graphene-like material, suggesting to us that the original mixture is meta-stable.

Our results suggest that models for the structure of graphene oxide need revisiting. The presence of oxidative debris in the as-produced GO has important implications for the synthesis and application of CMGs, particularly where direct covalent functionalisation of the graphene lattice is required. The purified GO material of the invention thus represents a novel and promising material both for future research and for use in small scale electronic components.

Graphene oxide has a number of potential uses on account of its properties. Graphene oxide differs from graphene in the sense that it has a different, more complex (and more reactive) chemical functionality, lower and variable/controllable conductivity somewhat lower (but still excellent) mechanical properties. Its composition can vary in terms of C:O ratio and also the proportions of the various oxygen based functional groups. This allows the potential to tailor properties such as conductivity. The reactivity of the functional groups may be a significant advantage since they will bond (covalently or non-covalently) with a wide variety of polymers and resin systems. The functional groups can also be used as a starting point for surface modification reactions to produce other forms of functionalised graphene with controlled properties and resin and polymer compatibility.

A key advantage of the material of the present invention is that it isolates the GO platelets from oxidative debris and this will result in a much greater realisation of properties in end use applications. Frequently, the platelet size of GO will depend on the source and method of manufacture of the GO prior to treatment with NaOH.

The inclusion of GO in polymeric or resin systems can be expected to enhance properties such as strength, modulus, crack resistance, fatigue performance, fracture toughness, wear and scratch resistance, glass transition temperature, modulus at elevated temperature, chemical resistance, resistance to ultraviolet radiation, fire resistance, gas barrier performance, gas barrier selectivity, control of coefficient of thermal expansion, thermal and electrical conductivity, control of thermal and electrical conductivity, infrared absorption, rheological characteristics (for example elongational flow characteristics). By controlling C:O ratio it will be possible to fine tune properties such as electrical conductivity. This will allow very highly controlled resistivity to be obtained in circumstances where more highly conductive fillers would show a considerable change in resistivity for only a small change in filler content.

GO is expected to be useful in a number of polymer and resin systems. Again, this is due to the unusual properties of the GO of the invention and the fact that these properties can be controlled by varying the C:O ratio. The ability to further functionalise the surface allows the properties to be customised for use in a particular polymer system. For example, by controlling the C:O ratio (and possibly using the reactive species to introduce other surface chemistries) it is possible to control the strength of interactions with a wide range of polymers. These include, but are not limited to the following polymers and their copolymers: polyolefins, polycarbonates, polyacrylates, polyamides, polyesters, polyethylene terephthalate, polybutylene terephthalate, polyacetal, polyvinylalcohol, polyvinylacetate. polyethers, polyarylates, polylactides, polycaprolactones, polystyrene, acylonitrile-butadiene-styrene polymers, polyacrylamides, vinyl acetate polymers, cellulosic polymers, polyurethanes, polyethersulfones, polyetherimides, polyphthalamides, polyphenylenesulfides, polyaryletherketones, polyamideimides, polyimides, polybenzimidazoles, liquid crystalline polyesters, fluoropolymers, polyacrylonitrile, elastomers and rubbers.

Some resin systems will show improved bonding due to non covalent interactions. In other cases direct covalent bonds can form with reactive resins; for example with epoxy resins, isocyanates and imides or through transesterification with polyesters. This will improve mechanical properties and allows for smaller reinforcing platelets due to improved interfacial stress transfer characteristics. It will also improve other properties such as aspects of chemical resistance. There is considerable potential for the use of GO in curable resins such as thermosets. The reaction process may occur during or prior to the final curing and/or crosslinking of the resin. Such a GO modified resin may be used in combination with other reinforcements such as glass, carbon and kevlar fibres, mineral fillers and carbon nanotubes. Compatabilising agents which can bond to both the GO surfaces and the polymers, resins and/or reinforcing fibres may also be used. These may be in form of small molecules (such as maleic anhydride) or oligomers or functionalised polymers and/or block copolymers. GO oxide may also be added to carbon fibre precursor materials such as pitch, polyacrylonitrile or aramid solutions so as to improve the properties of the resultant fibres. The GO may be incorporated in high strength fibres; low creep fibres; high modulus fibres and find use in areas such as in awnings, conveyor belts, release fabrics, high performance ropes, body armour, protective braiding.

In addition the reactive oxygen containing groups can be converted to a wide range of other species with a corresponding range of reactive or inert pendant groups. These include for example esters and amides. The surface oxygen species may be converted to fluorine. Thus, the GO of the invention represents a useful starting point for a number of derivatised graphene compounds.

This range of improved properties, polymers, resins and chemistries based on the GO of the present invention has the potential to improve performance in a very wide range of applications. These include: barrier systems, for example in food packaging; pharmaceutical packaging; rubber and elastomeric hoses; tyres and inner tubes; tanks hoses and containers for fuels, gases and chemicals; perfume packaging; packages for environmentally sensitive chemicals; electronic device encapsulation; gloves; protective equipment; chemical warfare clothing. Barrier systems with combined electrostatic dissipation properties—such as hoses and tanks for flammable liquids and gases and some housings for electronic devices. Enhanced mechanical performance may also benefit these applications for example by improving durability or by allowing reduced cost through reduced component weight. The material may also be incorporated in healthcare sterilisation and transport containers; catheters and laparoscopic tubes benefiting from stiffness.

The GO of the invention may also find utility in systems requiring controlled electrostatic dissipation, electrical conduction or antistatic properties such: housings and connectors for electronic equipment; devices and equipment used in the manufacture of silicon and conducting polymer based integrated circuits for example silicon wafer carriers, robotic wands, test and burn in sockets; components which are painted by means of electrostatic spray technology; shielded medical equipment; conductive, antistatic or electrostatic dissipative coatings, paints and inks; ink formulations for conductive, printable electronics; printable RFID components; foams; UV stabilised components, thermal management devices; conductive, antistatic or electrostatic dissipative foams; foams, films and fibres made by processes benefitting from modified elongational viscosity; conductive, antistatic or electrostatic dissipative fibres.

The GO of the invention could also be used in electrical applications such as for electrodes; battery electrodes; fuel cell bipolar plates; super capacitors; printed circuit boards; flexible electronics substrates; infrared absorbing additives used for example in blown bottle and thermoformed polymer formulations

The mechanical properties of the GO of the invention also renders it suitable for mechanical reinforcement for thermoplastic and thermosetting polymers and resins and their associated chopped fibre and continuous fibre reinforced compounds and composites. Such materials may be used a very wide range of applications, for example: mass transit applications benefitting from properties such as enhanced mechanical performance, reduced weight and fire resistance. Other applications of GO-based composites might include: aircraft primary structures such as wings and fuselages; secondary structures such as floor panels, seats, passenger service units, access hatches and engine fairings.

The mechanical strength of the GO of the invention and its effect on polymers or alloys into which it is incorporated provide useful properties that can be exploited in mechanical components such as engine and transmission components; seal rings; thrust washers; bearings; gaskets; friction washers; bushings; fork pads; sensor housings; connector linings; tanks; pipes; tank and pipe linings; fuel lines; fuel filter housings; fuel tanks; fuel tank manhole covers; fuel tank linings; vacuum pump vane tips; backup rings; piston rings; sleeves; lubricant free wear plates; O rings; shaft seals; thermostat housings; fuse holders; exhaust gas recirculation components; air intake manifolds; oil control pistons; throttle bodies; ignition components; bearing retainers and cages; gears; vacuum pump vanes; measurement probes.

Further expected uses of GO include a range of applications such as for example in: films; self adhesive tapes; braided fibre; thermal, acoustic and burn though insulation; fire barriers; cable ties; tubes; catheters; bolts; nuts; inserts and brackets; gas separation membranes; heat exchanger components; analytical equipment components; food processing equipment; cooking equipment; pump, valve and impellor housings and liners; valve plates; bellows; lined pipes; ball and roller bearing components; bearing films; sliding bearing pads; expansion joints; coated metal components; over braided hoses; laboratory ware; conveyor belts; roll coverings; heat sealing materials; corrugated tubing; oilfield down hole instruments; pipes and hoses; pipe and hose liners; oilfield riser liners; drill bit seals; umbilical liners; chemical process equipment; chemical process instrument housings and seals; labyrinth seals; compressor components; gas flues; wire guides; yarn and thread guides; metallised films; release films; heat sealable tubing, shrinkable tubing; extruded and irradiated heat shrinkable tubing; coatings: exterior and interior coatings for example on pipes, tanks, ducts, bearings, wear plates, protective sleeves, industrial rollers, copier rollers, split fingers, process belts, pumps, valves, medical devices, drill bits, food processing equipment, cooking equipment, non stick cookware and bakeware; protective and decorative coatings; UV resistant coatings; and coated fabrics.

Synthesis of Graphene Oxide (GO)

GO was prepared via a modified Hummers' method following the method reference above. Natural flake graphite (Graphite Trading Company, 5 g) and KNO3 (4.5 g) were suspended, with stirring, in concentrated sulfuric acid (169 ml). The mixture was cooled in ice and KMnO4 (22.5 g) was added over 70 mins. The mixture was then allowed to warm to room temperature (with stirring) and then left to stir for 7 days. The mixture became thicker with time, and after about 3 days stirring became impossible. The dark mixture was then slowly dispersed into 550 ml 5 wt % H2SO4 in water (approx 1 hour) and stirred for a further 3 hours. Hydrogen peroxide (15 g, 30 vol) was added over 5 mins with considerable effervescence; the mixture turned into a yellow/gold glittery suspension and was stirred for a further 2 hours. The mixture was then further diluted with 500 ml of 3 wt % H2SO4/0.5 wt % H2O2 and left to stir overnight. The mixture was then centrifuged at 8,000 rpm for 20 mins, which resulted in the separation of the mixture into two roughly equal portions, together with a small quantity of very dark coloured pellet (which was discarded). One of the portions was a clear supernatant liquid (which was decanted and discarded) the other being a thick dark yellow viscous liquid. The viscous liquid was then dispersed with vigorous shaking (5-10 mins) into a further 500 ml of 3 wt % H2SO4/0.5 wt % H2O2. This washing procedure was repeated 12 times, during which the viscous fraction became progressively less glittery and progressively darker, such that by the 4th washing no glitter was visible. The mixture was then washed with pure water (500 ml) and concentrated via centrifugation (discarding the colorless supernatant) until the supernatant was neutral (pH 7) (5 washing cycles). This gave a dark browny-orange viscous liquid (aGO) which can be used directly as an aqueous suspension of GO (approx concentration 3 mg ml-1) or can have the remaining water removed via high speed centrifugation (20,000 rpm, 30 mins) and vacuum drying.

Base Wash

50 ml of aGO suspension in water (approx. 150 mg of dry aGO) was diluted with pure H2O to a volume of 250 ml and stirred for 24 hours. 1 g (0.025 mol, accurately weighed) of solid NaOH was added slowly, ensuring complete dissolution (effective concentration of NaOH is now 0.1 mol dm-3), during this process the mixture darkened appreciably. The mixture was then brought to reflux, resulting in a separation of the suspension into a very lightly colored liquid and black coagulated particles. After cooling to room temperature the mixture was centrifuged at 11,000 rpm for 30 mins resulting in a black pellet and an almost colorless liquid. The supernatant liquid was decanted and put on one side (OD). The black pellet was then re-acidified with 250 ml of 1 M HCl and refluxed for a further hour. Centrifugation at 11,000 rpm for 30 mins allowed the separation of the black substance from a colorless supernatant (which was combined with the previous supernatant). The black pellet was washed with pure water (250 ml) and recentrifuged at 20,000 rpm for 30 mins. The black pellet from this final washing was dried under vacuum and weighed (bwGO powder).

Yield of bwGO and OD

In order to establish the precise weight of aGO used for each base wash, two equal mass portions of the same aGO suspension were accurately weighed into flasks: one was treated as above (NaOH, HCl, H2O), whereas the other was simply refluxed in H2O as a control. The water was removed from this control by centrifugation (20,000 rpm, 30 mins) and then the GO dried under vacuum. The proportion of bwGO produced can then be calculated simply as the mass collected divided by the mass of GO. We also measured the yield of oxidation debris directly. In order to establish the mass of oxidation debris, the decanted supernatants from the NaOH, HCl and water treatments were combined, checked to establish the pH was acidic and then the water was removed under vacuum. The as-collected oxidation debris is contaminated with NaCl, resulting from the neutralizing of the NaOH used to wash the GO, but by accurately weighing the added NaOH we can calculate the mass of NaCl produced. This mass can then be subtracted from the yield of oxidation debris+NaCl to give the true mass of oxidation debris. Though we measured the yield of bwGO on four separate occasions, we only measured the yield of OD three times:

| | Run 1 | Run 2 | Run 3 | Run 4 | Average |
|---|---|---|---|---|---|
| Mass of aGO | 0.1474 g | 0.1250 g | 0.1545 g | 0.1596 g | |
| Yield of | 0.0928 g | 0.0825 g | 0.0991 g | 0.0997 g | |
| bwGO | | | | | |
| Yield of OD | 0.0611 g | — | 0.0281 g | 0.0517 g | |
| % bwGO | 63% | 66% | 64% | 62% | 64 ± 2% |
| % OD | 41% | — | 18% | 32% | 30 ± 9% |

Note that the mass of OD and bwGO were measured independently, but within experimental error mass balance was still achieved from these two components alone.

Thermogravimetric Analysis (TGA)

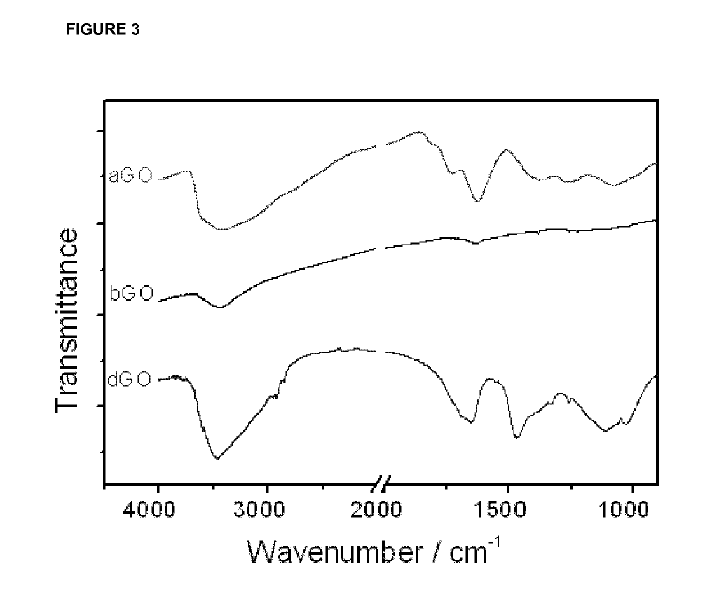

aGO, bwGO and OD powder were dried under vacuum prior to TGA analysis in a Metler-Toledo TGA/DSC1 system. Analysis was in air, at a heating rate of 10° C. min-1. The OD powder as dried is mainly NaCl salt; for GO, base washed in 250 ml 0.1 M NaOH, we expect the OD powder to contain 1.461 g of NaCl. If the mass of OD produced is 0.0281 g, this corresponds to 98.8%, whereas if the mass of OD produced is 0.0611 g this corresponds to 96% of the mass. Using such an analysis, we would expect the proportion of NaCl in the sample used to generate FIG. 3 to be 97.4%. Whilst the mass remaining at 700° C. (which we can reasonably expect to be only NaCl) is a little bit lower than this (96%) we attribute this discrepancy to uncertainties in the yield of OD and manipulation errors. The slight upturn in the mass fraction observed for the oxidative debris in FIG. 2 (bottom) is likely to be an artefact, possibly due to deviations in baseline between the reference scan (which is taken to provide a baseline to be subtracted from the recorded data) and the analysis scan.

1. A method for the preparation of graphene oxide, wherein the method comprises the steps of:
1) treating a mixture comprising graphene oxide and impurities with a solution of a base; and
2) separating graphene oxide from the basified impurities.

2. The method of claim 1, wherein the solvent used for the base is selected from the group consisting of water and a C1-C4 alcohol.

3. The method of claim 2, wherein the base is an aqueous solution of a base.

4. The method of claim 3, wherein the base is a carbonate, a bicarbonate, a hydroxide, or an alkoxide of a group 1 metal, or a carbonate of a group 2 metal.

5. The method of claim 1, wherein the concentration of the base is between 0.001 M and 10M.

6. The method of claim 1, wherein the treatment with base occurs at a temperature between −10° C. and 200° C.

7. The method of claim 1, wherein the graphene oxide is prepared using the Hummers method.

8. A method for the preparation of graphene oxide, wherein the method comprises the steps of:
1) oxidising graphite to provide graphene oxide;
2) isolating a mixture comprising graphene oxide and impurities;
3) treating the the mixture with a base,
4) optionally repeating the step one or more times; and
5) separating graphene oxide from the basified impurities.

9. A method for the preparation of graphene, wherein the method comprises the steps of:
1) oxidising graphite to produce graphene oxide;
2) isolating a mixture of graphene oxide and impurities;
3) treating the mixture with a base;
4) separating graphene oxide from the basified impurities; and
5) converting the purified graphene oxide to graphene under reductive conditions.

10. A method for the preparation of chemically modified graphenes wherein the method comprises the steps of:
1) oxidising graphite to produce graphene oxide;
2) isolating a mixture of graphene oxide and impurities;
3) treating the mixture with a base;
4) separating graphene oxide from the basified impurities and
5) converting the purified graphene oxide to chemically modified graphenes by reaction with one or more chemically reactive species.

11. Graphene oxide substantially free of non-covalently bound oxygen-containing species.

12. Graphene oxide as claimed in claim 11, wherein at least 80% by weight of the material is covalently bound oxygen-containing material.

13. Graphene oxide as claimed in claim 12, wherein at least 95% by weight of the material is covalently bound oxygen-containing material.

14. Graphene oxide as claimed in claim 11, wherein the graphene oxide has an atomic C:O ratio of between 20:1 and 1:1.

15. The use of Graphene oxide prepared according to claim 1 for inclusion in a polymer or resin system.

16. A polymer or resin system incorporating graphene oxide prepared according to claim 1.

17. A polymer or resin system incorporating graphene oxide prepared according to claim 8.

18. A polymer or resin system incorporating graphene oxide prepared according to claim 9.

19. A polymer or resin system incorporating graphene oxide prepared according to claim 10.

20. Graphene oxide according to claim 12, wherein the graphene oxide has an atomic C:O ratio of between 20:1 and 1:1.

21. Graphene oxide prepared according to claim 1.

22. Graphene oxide prepared according to claim 8.

23. Graphene oxide prepared according to claim 9.

24. Graphene oxide prepared according to claim 10.
